(19) United States
(12) Patent Application Publication
(10) Pub. No.: US 2006/0157886 A1
(43) Pub. Date: Jul. 20, 2006

(54) Method and apparatus for continuously producing discrete expanded thermoformable materials

(75) Inventors: Thomas St. Denis, Rowayton, CT (US); Gabriel M. Karamanis, Stamford, CT (US); Mark Austin, New Rochelle, NY (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: PANTERRA ENGINEERED PLASTICS, INC

(21) Appl. No.: 11/292,644

(22) Filed: Dec. 2, 2005

Related U.S. Application Data
(60) Provisional application No. 60/632,398, filed on Dec. 2, 2004.
(60) Provisional application No. 60/632,420, filed on Dec. 2, 2004.
(60) Provisional application No. 60/632,397, filed on Dec. 2, 2004.
(60) Provisional application No. 60/676,407, filed on Apr. 29, 2005.

(51) Int. Cl. B29C 47/00

(52) U.S. Cl. 264/148; 264/210.2; 264/211; 425/4 C

(57) ABSTRACT

A method and apparatus for continuously and cost-effectively producing expanded thermoformable materials encompassing the steps of: providing raw thermoformable material into an extruder or mold; heating the material in the extruder or mold; extruding or co-extruding molding planar sheet material of suitable engineering performance parameters to a gauge and width; cutting or shearing the extruded or molded material while it is still hot to suitable lengths for expansion in a coreformer; conveying the hot thermoformable sheet material in between forming platens; heating the thermoformable material to a temperature at which the material adhesively bonds to the platens; expanding the cross-section of the thermoformable material; and then cooling the expanded thermoformable material by changing the temperature of the forming platens such that the thermoformable material can maintain its structural integrity and be released from the platens.

### CROSS-REFERENCED APPLICATIONS

This application claims priority to U.S. Provisional Patent Application No. 60/632,398, filed on Dec. 2, 2004, U.S. Provisional Patent Application No. 60/632,420, filed on Dec. 2, 2004, U.S. Provisional Patent Application No. 60/632,397, filed on Dec. 2, 2004, and U.S. Provisional Patent Application No. 60/676,407, filed on Apr. 29, 2005, all of which are hereby incorporated by reference in their entirety.

### BACKGROUND OF THE INVENTION

1. Field of the Invention

The present invention relates to a method of producing expanded thermoformable materials. More particularly, the present invention relates to a cost effective and energy efficient method for continuously producing expanded thermoformable materials with open or closed cell wall structures.

2. Description of the Prior Art

Processes used to make expanded thermoformable materials typically involve placing a thermoformable polymeric material blank between mold plates, which are attached to a heated press. The thermoformable polymeric material blank is heated to a temperature at which the thermoformable material will adhesively bond with the mold plates by hot tack adhesion. The mold plates are then separated with the thermoformable material still adhered to the mold plates, so as to affect an expansion of the cross-section of the thermoformable material.

Typically, the surfaces of the mold plates that are bonded to the thermoplastic material blank have a plurality of perforations thereon. The thermoplastic material will adhesively bond to the non-perforated portion of this surface so that when the mold plates are separated a plurality of cells will be formed within the cross-section of the expanded thermoformable material. Generally, these perforations can have a variety of different geometries and can be arranged in an array of patterns on the surface of the mold plates, thereby creating thermoformable materials having a variety of cross-sectional geometries. Such methods for expanding thermoformable materials are set forth in U.S. Pat. No. 6,322,651, issued on Nov. 27, 2001 to Phelps, U.S. Pat. No. 4,113,909, issued on Sep. 12, 1978 to Beasley, U.S. Pat. No. 4,164,389, issued on Aug. 14, 1979 to Beasley, U.S. Pat. No. 4,315,051, issued on Feb. 9, 1982 to Rourke, U.S. Pat. No. 4,269,586 issued on May 26, 1981 to Ronayne, U.S. Pat. No. 4,264,293, issued on Apr. 28, 1981 to Rourke, and U.S. Pat. No. 4,315,050 issued on Feb. 9, 1982 to Rourke, each of which is incorporated herein by reference in their entirety.

One disadvantage with these processes is that there are large economic losses due to the use of discrete thermopolymer sheets. These sheets are made from thermoplastic resin which is heated to a high temperature to cause it to melt and be formed through dies under pressure. After extrusion from the dies the sheet material is polished to give it a good finish, cooled, sealed and cut. Then it is stored and eventually transported to a coreformer or expander where it must be unsealed and reheated before being formed into expanded honeycomb core product. The process of expanding the thermopolymer sheet destroys the polish that the sheet had been given during the extrusion process. There are multiple sources of waste associated with this process, namely the additional manpower and time needed to perform these tasks.

In addition, the cost of production is substantially increased because of the amount of wasted energy in these conventional processes. Each thermoformable sheet material must be reheated since all of the energy from the original heating of the resin in the extruder is lost. The current methods require the thermopolymer material used to manufacture the expanded honeycomb core product to be cooled twice, once after extrusion and once after expansion. Thus, the cost of production is increased because energy must be purchased to heat each new sheet of thermoformable material prior to expansion, and all of this energy is wasted during the initial cooling process.

A further disadvantage of the previous methods is that many of the thermoformable materials are hydrophilic and absorb moisture from the air. This moisture must be removed prior to expanding the material for two reasons. First, the moisture will absorb heat and unnecessarily require additional energy to bring the thermoformable material up to expansion temperature. Secondly, and perhaps more importantly, the moisture in the thermoformable material will expand as it turns to vapor at the thermoforming temperatures resulting in voids, fissures and other defects in the finished expanded honeycomb core product, making it structurally unsound and commercially unacceptable. To make acceptable expanded honeycomb core product from thermoformable sheet material, that material needs to be heated in an oven to drive off the absorbed moisture. This of course is an additional step that requires energy, manpower, time, floor space, additional equipment and ultimately cost.

All of these processes envision a monolithic thermoformable sheet material as the starting point for the thermoforming expansion process. Typically, these materials are produced by an extruder of a known thermoplastic such as ABS, polypropylene, polystyrene, polycarbonate, etc. In reality, the process of efficiently forming a good quality expanded thermoformable material requires a more sophisticated understanding of the material's viscoelastic properties.

Furthermore, another disadvantage of the conventional processes described above are that they are neither automated nor continuous from the input of the raw material to the finished product, and typically require multiple manufacturing personnel, multiple heating and cooling stages, and other steps that are necessary to produce one expanded thermoformable product. Obviously, the use of multiple personnel greatly increases the cost of manufacturing, together with the long product cycle times and energy loss.

Finally, the existing processes have inherent limitations in terms of volume throughput and capacity and the ability to scale-up to meet large customer demands. All the aforementioned processes are batch processes and cannot deliver volume production yields. At the same time, the built-in economic and energy disadvantages of these processes make them impractical in meeting the requirement of large scale demand.

Accordingly, there is a need for an improved method of continuously producing expanded thermoformable materials that avoids the aforementioned disadvantages.

It is an object of the present invention to provide a method for producing expanded thermoformable materials that allows for the continuous processing of the materials.

It is a further object of the present invention to provide a method for producing such materials that directly integrates the forming and processing of the raw material inputs.

It is a further object of the present invention to provide a method for producing the materials that substantially reduces the product cycle time, labor costs, and energy consumption of the systems and methods currently available.

It is a further object of the present invention to provide a method for producing a material that substantially improves the volume production capacity and throughput of currently available systems.

It is a further object of the invention to prevent the absorption of water by the thermoformable material, which saves on labor costs and improves the processing time of said materials over currently available systems.

### SUMMARY OF THE INVENTION

The present invention provides a cost-effective and energy efficient method for continuously producing expanded thermoformable materials. This method comprises the steps of: providing raw thermoformable material (such as thermoplastic flake or pellets) into an extruder or molds; heating the material in the extruder or molds; extruding or molding planar sheet material as a single extrusion or co-extrusion of suitable gauge and width; cutting or shearing the extruded or molded material to suitable lengths for expansion in a coreformer or expander while it is still hot; conveying this hot thermoformable material into a coreformer or expander having heating and cooling platens with an arrangement of holes on one or both forming platens; expanding the heated thermoformable material in this expansion and cooling module; and cooling the expanded thermoformable material by changing the temperature of the platens to facilitate release from the platens and to maintain the structural integrity of the thermoformable material.

In another embodiment of the present invention, a buffer or loader can be located between the extruder or mold and the coreformer or expander. The buffer or loader can hold the formed sheets of material and keep them at an elevated temperature before they are conveyed to the coreformer or expander.

In another embodiment of the present invention, the heating expansion and cooling of the core material can be performed at distinct and separate stages of the coreformer or expander.

In another embodiment of the present invention, the raw thermoformable material supplied to the extruder or mold can be a heterogeneous mixture. This mixture can be co-extruded so that the sheet of material conveyed to the coreformer or expander has an outer and inner layer of material.

In another embodiment of the present invention, the raw material selected can contain physical properties, such as low viscoelasticity, that allow for the formation of holes or tears in the side of the formed material. These holes or tears can allow for the passage of materials through the finished material.

In another embodiment of the present invention, fibers can be added to the raw materials used to make the core material.

In another embodiment of the present invention, fillers can be added to the raw materials used to make the core material.

In another embodiment of the present invention, nanotubes, especially carbon nanotubes, can be added to the raw materials used to make the core material.

In another embodiment of the present invention, the fibers, fillers, or the nanotubes added to the raw materials described above are conductive or have other electrical, electrostatic or electromagnetic properties.

In another embodiment of the present invention, rubber or other flexible polymeric material can be added to the raw materials.

In particular, the present invention includes a method for forming an expanded thermoformable material, said method comprising: feeding said thermoformable material to an extruder which heats said thermoformable material and thereafter extrudes a thermoformable sheet or layer; and conveying said thermoformable sheet to an expander (e.g., press expander), wherein said expander expands a cross-section of said thermoformable sheet to form a core layer having a thickness larger than said thermoformable sheet and wherein air cells are disposed throughout said core layer. The method may further comprise the step of conveying said thermoformable sheet to a buffer loader prior to conveying said thermoformable sheet to said expander. Preferably, the buffer loader has a heated environment to maintain said thermoformable sheet at a predetermined temperature. The buffer loader is capable of storing at least one thermoformable sheet therein. Furthermore, the method may optionally include a step of cutting said thermoformable sheet into predetermined lengths before conveying said thermoformable sheets to said buffer loader. The expander can also comprise a separate heating station and cooling station.

The thermoformable material can also be a heterogeneous mixture of thermoplastic material, such that a thermoformable sheet is formed which comprises at least two layers of differing thermoplastic materials.

The thermoformable material can also have a low viscoelasticity, such that upon expansion in the expander, tears or holes are formed in the core layer cell walls.

All of the above embodiments can further have a system that can control the combined extrusion and coreforming process, such as by regulating temperature, rate of movement of the materials, buffering or loading of the extruded sheets, expansion of the material, cooling, loading, unloading, or any other aspect of the present invention.

### BRIEF DESCRIPTION OF THE DRAWINGS

FIG. 1 is a block diagram according to a first embodiment of the present invention;

FIG. 2 is a block diagram according to a second embodiment of the present invention;

FIG. 3 is a block diagram according to a third embodiment of the present invention;

FIG. 4 is a block diagram depicting a process utilizing heterogeneous raw materials according to the present invention;

FIG. 5 is schematic representation of a cross-sectional side view of a conventional core material with internal cells; and

FIG. 6 is schematic representation of a cross-sectional side view of a core material with the lateral open cell structure according to the present invention.

### DETAILED DESCRIPTION OF THE INVENTION

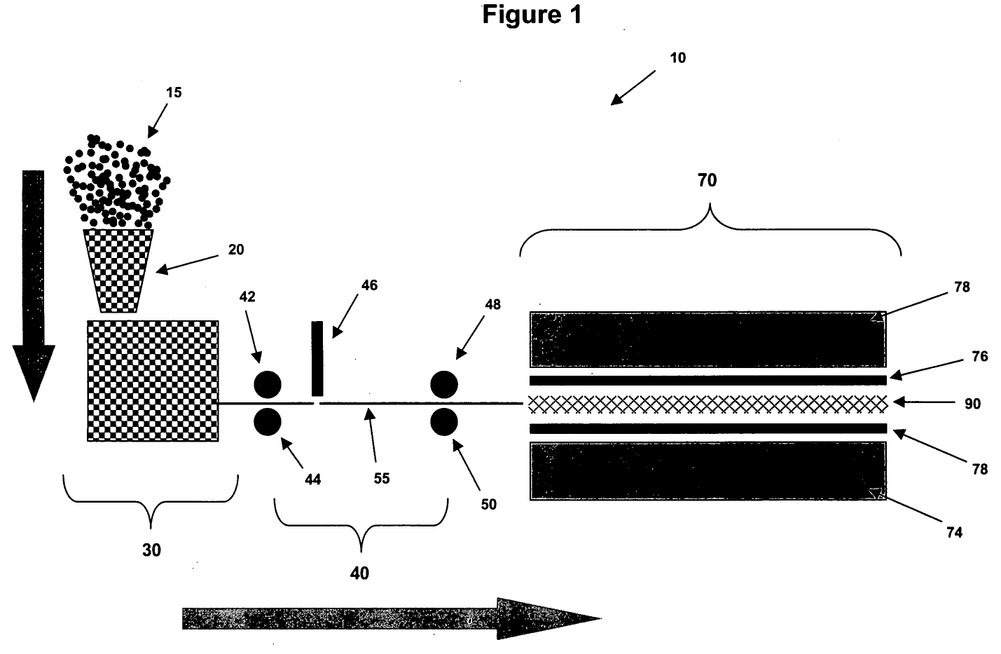

Referring to FIG. 1, a first embodiment of the present invention, generally referred to by reference numeral 10, is shown. System 10 has hopper 20, extruder 30, conveyor system 40, and coreformer or expander 70.

To begin the process of the claimed invention, thermoplastic raw material 15 is loaded into hopper 20. This material is usually in pellet form. Suitable examples of such material include, but are not limited to, high impact polystyrene, polycarbonate, acrylonitrile butadiene styrene, homo or co-polymer polypropylene, low and high density polyethylene and combinations thereof.

Hopper 20 then feeds the raw material into extruder 30. These materials can be extruded or molded utilizing unfilled polymers, polymer alloys, fiber/filler/nano reinforced polymers, flexible polymers, recycled polymers or combinations of the above. Inside extruder 30, the raw material is heated to a temperature as high as about 300° C., at which point the material becomes a viscous liquid. In this state, it is forced through under pressure, typically by a screw pump mechanism, through a set of dies generally in the shape of a flat sheet. While the present invention can form expanded material from a variety of thicknesses, about 0.100″ to about 0.250″ inches represents a common starting thickness.

By the time the material has been forced through the dies into sheet form, it has cooled to approximately about 250° C., and, while it is still soft and flexible, it is no longer in a liquid state. The material exits extruder 30 in the form of a sheet, referenced in FIG. 1 by numeral 55. Thermoplastic sheet 55 passes through first upper and lower rollers 42 and 44, which guide sheet 55 to a shear mechanism 46. Shear mechanism 46 cuts sheet 55 into the desired lengths. In the shown embodiment, shear mechanism 46 is a simple vertical cutting shear; however, other methods of cutting sheet 55 into the desired lengths are contemplated by the present invention, including but not limited to using laser cutters or a water jet.

Sheet 55 then passes through a second set of upper and lower rollers 48 and 50, which guide sheet 55 to coreformer or expander 70. In general, it is desirable to keep sheet 55 as hot as possible prior to its entering the coreformer or expander so as to minimize the amount of energy used in re-heating it. Sheet 55 should only be allowed to cool to the minimal temperature necessary to prevent it from gross distortions of shape during the brief transit time from extruder to coreformer or expander. This is a substantial advantage over currently available systems. Since sheet 55 is kept at an elevated temperature at this point, the material sheet 55 does not cool completely, which saves on the energy and manpower costs that would be involved in reheating the sheet later on. In other words, the present invention eliminates the substantial costs of heating the thermoformable material from ambient temperature to the temperature at which it will adhere to the platens of the coreformer or expander (discussed below). Waste heat from the process of cooling the expanded thermoformable material (discussed below) can be reused to help maintain the extruded material at a high temperature. Additionally, keeping sheet 55 hot between extruder 30 and coreformer or expander 70 eliminates the need to remove moisture from sheet 55 because the temperature of the material is high enough to prevent water from being absorbed. Since the process is continuous, the transit time between extruder 30 and coreformer or expander 70 is minimized, which also helps to prevent the absorption of water by sheet 55. This results in lower labor costs and helps to improve the overall cycle time of the machine. Finally, since the sheet 55 is kept at an elevated temperature during the entire time from when it leaves the extruder 30 and before it enters coreformer or expander 70, the present invention eliminates the substantial amount of time to reheat the thermoformable material that is needed by currently available systems.

Sheet 55 is then conveyed to coreformer or expander 70. Coreformer or expander 70 has upper and lower presses 72 and 74. Coreformer or expander 70 further has upper and lower platens 76 and 78, which are operably connected to upper and lower presses 72 and 74, respectively. Once in coreformer or expander 70, upper and lower platens 76 and 78 heat sheet 55 to a temperature at which the thermoformable material of sheet 55 adhesively bonds to upper and lower platens 76 and 78, usually in the range of about 100° C. to about 400° C. The critical temperature at which the thermoformable material of sheet 55 will adhere to upper and lower platens 76 and 78 will depend on the characteristics of the material selected. Heated platens 76 and 78 can be composed of aluminum, copper, steel or other suitable metals and alloys.

Upper and lower press 72 and 74 then separate, pulling upper and lower platens 76 and 78 apart, and effecting an expansion of the cross-section of sheet 55 to the desired width. The surface of the platens 76 and 78 which comes into contact with the thermoformable material can have perforations thereon, thereby creating cells in the cross-section of the expanded thermoformable material during the expansion process. Alternatively, each set of coreformer or expander platens may have either the same or different diameter perforations thus enabling the creation of core material having different or the same cell cross-sections. The coreformer or expander platens can also have one platen with a pattern of perforations and one platen with a smooth face, so that the system can produce core material with an integral facing on only one side. An integral facing is defined a connected, homogeneous layer on one side of the core material.

Sheet 55, after being expanded by upper and lower platens 76 and 78 of coreformer or expander 70, is transformed into core material 90. Core material 90 is then cooled by changing the temperature of upper and lower platens 76 and 78, such that core material 90 is cooled to a temperature sufficient for maintaining its structural integrity and to facilitate release from upper and lower platens 76 and 78. Upper and lower presses 72 and 74 then retract, which retracts upper and lower platens 76 and 78 and releases core material 90. Core material 90 is ejected from the machine either by manual means or by an automated unloader system which pushes the core from the machine.

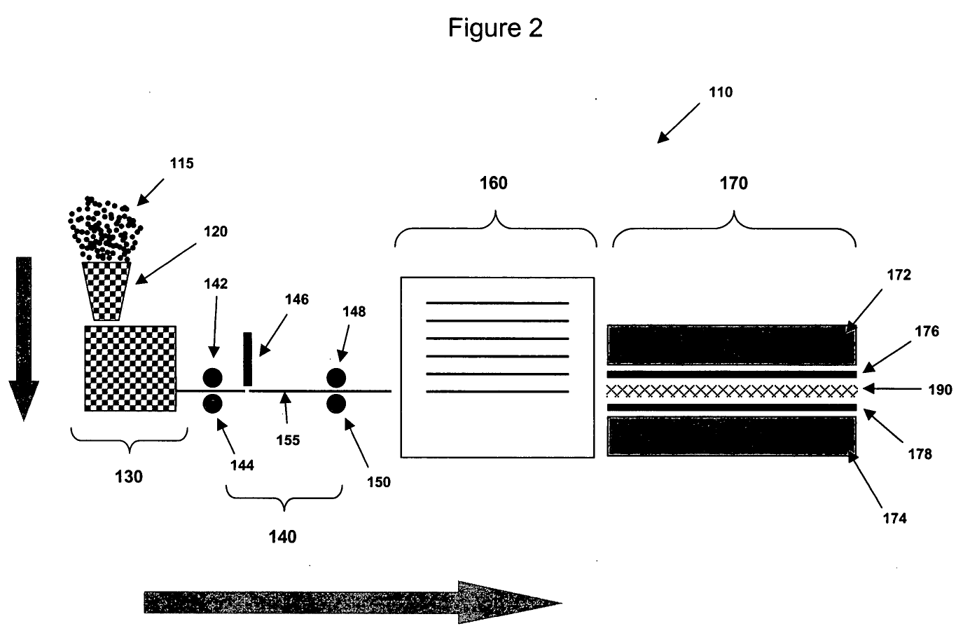

Referring to FIG. 2, a second embodiment of the present invention is shown, generally referred to by reference numeral 110. System 110 has hopper 120, extruder 130, conveyor system 140, and coreformer or expander 170, which are identical to the similarly numbered components of system 10 discussed above. System 110 also has buffer loader 160.

In system 110, the process for creating the thermoformable materials is the same as that of system 10, up until the point at which sheet 155 is loaded into buffer loader 160. Thus, raw materials 115 are fed into hopper 120, which guides material 115 into extruder 130. Extruder 130 forms sheet 155 out of raw materials 115. Sheet 155 is guided through first upper and lower rollers 142 and 144, and then to shear 146, which cuts sheet 155 to a desired length. Sheet 155 is then guided by second upper and lower rollers 148 and 150 to buffer loader 160.

Buffer loader 160 holds sheet 155 at an elevated temperature while it is waiting to be loaded into coreformer or expander 170. One advantage to this feature, as described above, is that ambient moisture is not absorbed by sheet 155. In addition, buffer loader 160 has the ability to hold multiple sections of sheet 155, which allows for different run rates between extruder 130 and coreformer or expander 170. This helps to ensure the efficient and cost-effective continuous production capability of system 110, and the minimization of manpower to keep the system running smoothly. This is particularly important, as extruders require significant amounts of time and energy to start up and to shut down. Finally, by keeping sheets 155 at an elevated temperature, buffer loader 160 helps to decrease the energy costs of the system because sheets 155 do not have to be reheated from room temperature once they are conveyed into coreformer or expander 170.

There are several possible configurations of buffer loader 160 that can be used in the system of the present invention. A preferred buffer loader includes racks large enough to hold a sheet of core with the racks mounted on a vertical drive mechanism that can move the racks up and down both for temporary storage as well as for aligning with the opening of the coreformer or expander and loading it. Another version would provide for the racks to be mounted on a continuous loop. Because the material sheets 155 stored by buffer loader 160 are hot and somewhat soft and flexible, the racks or shelves that the material rests on in buffer loader 160 must be made of appropriate materials to keep the shape of the material sheets 155 while being able to withstand the heat.

After sheets 155 are conveyed from buffer loader 160 into coreformer or expander 170, core material 190 is formed in the same way as core material 90 of system 10. Upper and lower platens 176 and 178 heat sheet 155 to the temperature at which sheet 155 will adhesively bond to upper and lower platens 176 and 178. Upper and lower platens 176 and 178 then retract, expanding sheet 155 into core material 190. Upper and lower platens 176 and 178 then cool core material 190 to a temperature sufficient for maintaining its structural integrity and to facilitate release from upper and lower platens 176 and 178. Upper and lower platens 176 and 178 then retract, releasing core material 190.

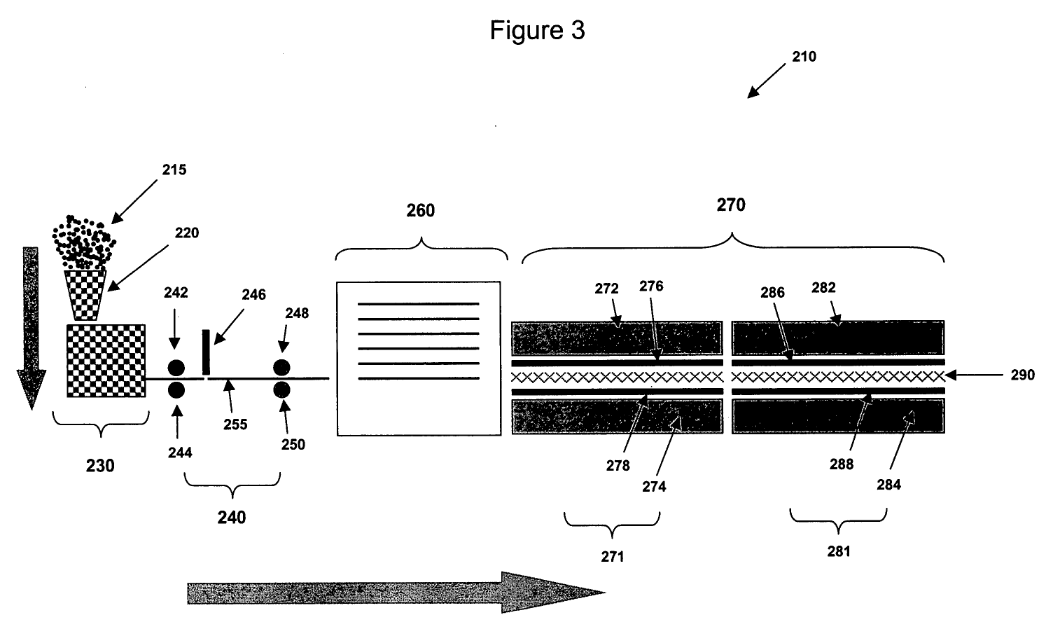

Referring to FIG. 3, a third embodiment of the present invention is shown, generally referred to by reference numeral 210. System 210 has hopper 220, extruder 230, conveyor system 240, and buffer loader 260, which are identical to the similarly numbered components of system 110 discussed above. System 210 also has coreformer or expander 270. Coreformer or expander 270 further has heating station 271 and cooling station 281.

System 210 performs in a substantially similar manner to system 110, with the important exception that there are two separate stages in coreformer or expander 270, as opposed to the coreformers of the above embodiments. Thus, when sheet 255 leaves buffer loader 260, it enters heating station 271 of coreformer or expander 270 first. Heating station 271 has upper heating press 272 and lower heating press 274. Upper and lower heating platen 276 and 278 are operably connected to upper heating press 272 and lower heating press 274 respectively. Upper and lower heating platens 276 and 278 engage sheet 255 and heat it to the temperature at which sheet 255 will adhesively bond to upper and lower platens 276 and 278. Similar to the embodiments described above, the platens then retract, expanding sheet 255 into core material 290. Core material 290 is then conveyed to cooling station 281, which has upper cooling press 282, lower cooling press 284, upper cooling platen 286, and lower cooling platen 288. The transfer of core material 290 into cooling station 281 is accomplished by a rotary chain belt, which pulls core material 290 into cooling station 281.

Upper and lower cooling platens 286 and 288 cool core material 290 to a temperature sufficient for maintaining its structural integrity and to facilitate release from upper and lower cooling platens 176 and 178. Upper and lower cooling platens 176 and 178 then retract, releasing core material 190.

Heating station 271 and cooling station 281 can be enclosed in a housing (not shown) capable of capturing the heat that escapes from core material 290 during the cooling process. This heat can be recycled to heating station 271 to heat a subsequent sheet 255, thereby conserving energy during operation of the continuous process. With this additional recycled energy heating station 271 can be kept at a high enough temperature to bring the sheet 255 to an adhesion temperature with a minimal amount of additional external energy.

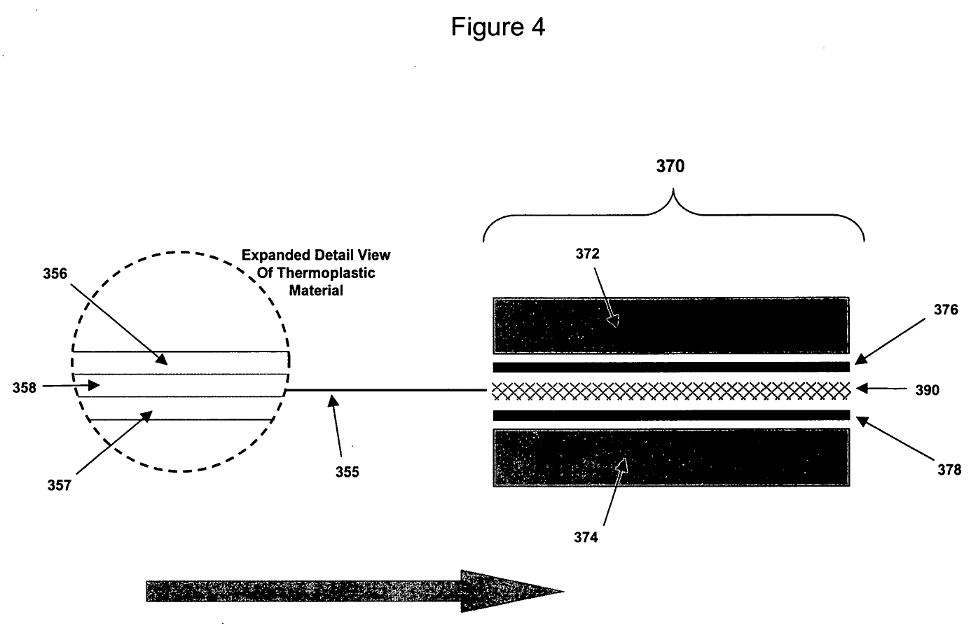

Referring to FIG. 4, another type of sheet that can be made by the extruder or molder of the above embodiments of the present invention is shown, and referred to by reference numeral 355.

To make sheet 355, heterogeneous raw material can be fed into the hopper, such as hopper 20 of system 10, hopper 120 of system 110, and hopper 220 of system 210. The raw materials can be extruded such that a three-layered sheet 355 is formed, having a top layer 356, bottom layer 357, and middle layer 358. Such a heterogeneous material can be made by a process known as co-extrusion, whereby different thermoformable materials are simultaneously extruded as layers into one sheet-type material. The methods for co-extrusion are known to those of ordinary skill in the art.

One advantage to the use of heterogeneous materials is that it can offer substantial energy savings over presently available systems. In one embodiment, for example, two materials can be selected for extrusion so that top layer 356 and bottom layer 357 of sheet 355 are made of the same material having excellent hot tack and adhesion properties at a low temperature. Middle layer 358 of sheet 355 can be made of a different material having excellent melt flow characteristics at a low temperature. Thus, this embodiment saves energy in the mold or extruder, because due to the melt flow characteristics of middle layer 358 less heat is required to melt the raw material than would otherwise be needed for a homogeneous mixture. Less energy is also required during the heating and cooling processes of coreformer or expander 370, because due to the hot tack properties of top and bottom layers 356 and 357 less energy is required to heat and subsequently cool sheet 355 during the formation of core material 390. In the shown embodiment, sheet 355 has three layers with the top and bottom layers being made of the same material; however, the present invention contemplates the use of a variety of different combinations and numbers of layers.

In another embodiment of the present invention, a raw material can be used that has reduced or low viscoelastic properties. The choice of a raw material with low viscoelasticity will be stiffer under the processing conditions of the coreformer or expander and this will cause the side walls of the internal cells to tear during a core material formation process such as those outlined above. The core material retains a sufficient amount of material and structure to the cell walls to maintain the strength and integrity of the overall core material sheet.

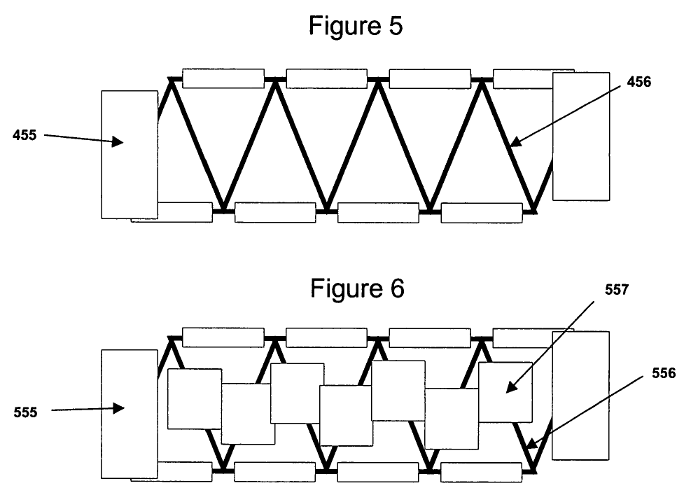

Referring to FIG. 5, a typical cross section of a core material 455 is shown. Core material 455 can have a number of side-walls 456 that retain the overall integrity of the core material. Referring to FIG. 6, a cross section of a core material 555 formed with the above described method is shown. Core material 555 can have a number of side walls 556, which have a number of tears 557 dispersed throughout. The tears 557, however, are not in such abundance that the overall structural integrity of core material 555 is compromised.

These tears 557 in the side walls 556 form holes that can allow air, liquids and even fine or granular solids to pass through parallel to the surface of the expanded thermoformable material. In addition, these lateral holes form a network of passageways from one end of core material 555 to the other, because the tears of one cell interface with the tears of adjacent tears in the core material. The combined effect of the lateral hole network and the through-hole network together with the rigidity and structure of the remaining cell wall, creates an expanded thermoformable material that is both porous yet strong and rigid.

In another embodiment of the present invention, fibers can be added to the raw materials during the extrusion process. These fibers can be made of a variety of materials, such as plastic, glass, carbon, and metal, all of an appropriate length and thinness so as to extrude properly in the sheet material. Such a thermoplastic sheet material, when expanded, will be significantly stronger as the fibers add strength to the cell walls between the two planar surfaces. The cell walls in the normal expansion process are thinner than the planar surfaces and the addition of the fiber, especially its content in the expanded cell walls, adds significantly to the finished core panels' compressive strength. The addition of the fiber, especially its content in the expanded panel's surfaces, adds significantly to the finished core panels' flexural strength. Due to the higher flexural strength of the finished product, a material of thinner starting thickness can be used to achieve the same performance that would normally result from a thicker material. This reduces the energy requirements needed to form the core due to the thinner mass to be heated.

In another embodiment of the present invention, nanotubes, especially carbon nanotubes, can be added to the raw materials during the extrusion process. These nanotubes act in a similar manner to fibers, but are easier to extrude in conjunction with the themoplastic, and the thermoplastic sheet is also easily formable into expanded core material. Such a thermoplastic sheet material, when expanded, will be significantly stronger as the nanotubes add strength to the cell walls between the two planar surfaces. The cell walls in the normal expansion process are thinner than the planar surfaces and the addition of the nanotubes, especially their content in the expanded cell walls, adds significantly to the finished core panels' compressive strength. The addition of the nanotubes, especially their content in the expanded panel's surfaces, adds significantly to the finished core panels' flexural strength. Due to the higher flexural strength of the finished product, a material of thinner starting thickness can be used to achieve the same performance that would normally result from a thicker material. This reduces the energy requirements needed to form the core layer due to the thinner mass to be heated.

In another embodiment of the present invention, the fibers or the nanotubes added to the raw materials described above are conductive or have other electrical, electrostatic or electromagnetic properties. Such a thermoplastic sheet material, when expanded, will assume these properties in addition to having the additional strength discussed above.

In another embodiment of the present invention, rubber or other flexible polymeric material can be added to the raw materials. The cell walls of the expanded thermoplastic material made from these sheets will have the ability to flex under pressure or impact. This gives the finished expanded thermoplastic panel the ability to absorb energy and return to its original shape without permanent deformation.

Any of the above described additives, namely, fibers, nanotubes, fibers or nanotubes with electrical properties, rubber, or other flexible polymeric material can be added to the raw materials used in any of the above described systems, namely, systems 10, 110, and 210. In addition, the above-described additives can be added to the raw materials used to form sheets 355, 455, and 555.

The present invention can also have a control system, using computer(s) software, sensors, actuators, and/or programmable logic controllers, used to control the extrusion, temperature, rate of movement, buffering, loading and unloading of the entire coreforming system, from raw material to finished product. Such a control system can be used in any of the above described embodiments of the present invention.

The present invention having been thus described with particular reference to the preferred forms thereof, it will be obvious that various changes and modifications may be made therein without departing from the spirit and scope of the present invention as defined herein.

What is claimed is:

1. A method for forming an expanded thermoformable material, said method comprising:
feeding said thermoformable material to an extruder which heats said thermoformable material and thereafter extrudes a thermoformable sheet or layer; and
conveying said thermoformable sheet to an expander, wherein said expander expands a cross-section of said thermoformable sheet to form a core layer having a thickness larger than said thermoformable sheet and wherein air cells are disposed throughout said core layer.

2. The method of claim 1, further comprising conveying said thermoformable sheet to a buffer loader prior to conveying said thermoformable sheet to said expander.

3. The method of claim 2, wherein said buffer loader has a heated environment to maintain said thermoformable sheet at a predetermined temperature.

4. The method of claim 2, further comprising a step of cutting said thermoformable sheet into predetermined lengths before conveying said thermoformable sheets to said buffer loader.

5. The method of claim 3, wherein said buffer loader is capable of storing at least one thermoformable sheet therein.

6. The method of claim 1, where said expander comprises a heating station and a cooling station.

7. The method of claim 1, where said thermoformable material is a heterogeneous mixture of thermoplastic material.

8. The method of claim 7, where said thermoformable sheet comprises at least two layers of differing thermoplastic materials.

9. The method of claim 1, where said thermoformable material has a low viscoelasticity.

10. The method of claim 1, wherein said thermoformable material further contains additives.

11. The method of claim 10, wherein said additives are selected from the group consisting of: fibers, nanotubes, flexible polymeric material, and any combination thereof.

12. The method of claim 11, wherein said additives have electrical, electrostatic, or electromagnetic properties.

13. The method of claim 1, wherein said expander is a press expander.

14. A system for forming an expanded thermoformable layer, said system comprising:
an extruder which melts thermoformable plastic material and extrudes a thermoformable sheet or layer; and
an expander that expands a cross-section of said thermoformable sheet to form a core layer having a thickness larger than said thermoformable sheet and wherein air cells are disposed throughout said core layer.

15. The system of claim 14, further comprising a buffer loader disposed between said extruder and said expander for storage of said thermoformable sheet from said extruder.

16. The system of claim 15, wherein said buffer loader has a heated environment to maintain said thermoformable sheet at a predetermined temperature.

17. The system of claim 15, further comprising a cutter which cuts said thermoformable sheet into predetermined lengths before storing said thermoformable sheets in said buffer loader.

18. The system of claim 16, wherein said buffer loader is capable of storing at least one thermoformable sheet therein.

19. The system of claim 14, where said expander comprises a heating station and a cooling station.

20. The system of claim 14, where said thermoformable material is a heterogeneous mixture of thermoplastic material.

21. The system of claim 20, where said thermoformable sheet comprises at least two layers of differing thermoplastic materials.

22. The system of claim 14, where said thermoformable material has a low viscoelasticity.

23. The system of claim 14, wherein said thermoformable plastic material further contains additives.

24. The method of claim 23, wherein said additives are selected from the group consisting of: fibers, nanotubes, flexible polymeric material, and any combination thereof.

25. The method of claim 24, wherein said additives have electrical, electrostatic, or electromagnetic properties.

26. The system of claim 14, wherein said expander is a press expander.

27. An expanded thermoformable material, said material comprising:
air cells disposed throughout the material, and
one or more additives.

28. The material of claim 27, wherein the additives are selected from the group consisting of fibers, nanotubes, flexible polymeric material, and any combination thereof.

29. The material of claim 28, wherein the additives have electrical, electrostatic, or electromagnetic properties.
